(19) United States
(12) Patent Application Publication
(10) Pub. No.: US 2010/0279773 A1
(43) Pub. Date: Nov. 4, 2010

(54) Motorized Game Controller

(75) Inventor: Jack Atzmon, Englewood, NJ (US)

Correspondence Address: COHEN, PONTANI, LIEBERMAN & PAVANE LLP, 551 FIFTH AVENUE, SUITE 1210, NEW YORK, NY, 10176, US

(73) Assignee: Ergowerx LLC, Englewood, NY (US)

(21) Appl. No.: 12/743,347

(22) PCT Filed: Nov. 17, 2008
(86) PCT No.: PCT/US08/12851

§ 371 Date: May 17, 2010

Related U.S. Application Data
(60) Provisional application No. 60/988,185, filed on Nov. 15, 2007.

(51) Int. Cl. A63F 13/06

(52) U.S. Cl. 463/38

(57) ABSTRACT

A game controller and system for operating the game controller. The game controller has a central hub and a pair of wings. The pair of wings are coupled to the central hub and configured to pivot about at least one axis with respect to the central hub. A method of operating a game controller includes connecting the game controller to at least one of a computer and a game console. Parameters are monitored including at least one of button presses, time, and wing position. A drive mechanism is activated based on the parameters, the drive mechanism varying a position of at least one of the pair of wings and the at least one button.

### CROSS-REFERENCE TO RELATED APPLICATIONS

This is a U.S. national stage under 35 USC §371 of Application No. PCT/US2008/012851, filed on Nov. 17, 2008 and claims priority to U.S. Provisional Application No. 60/988,185 filed on Nov. 15, 2007, the contents of which are incorporated herein by reference.

### BACKGROUND OF THE INVENTION

1. Field of the Invention

This invention relates to a game controller for a game and more particularly to a motorized game controller.

2. Description of the Related Art

A game controller is an input device used to control a video game. A controller is typically connected to a video game console or a personal computer. A game controller can be a keyboard, mouse, gamepad, joystick, paddle, or any other device designed for gaming that can receive input. The game controller is used to govern the movement or actions of an entity in a video or computer game. The type of element controlled depends upon the game, but a typical element controlled would be the actions and movements of a player's character.

### Gamepad

A gamepad, is the most common kind of game controller, held with both hands where the thumbs are used to provide input and can have anywhere from a two buttons to a dozen or more buttons, combined with multiple omnidirectional control sticks. Gamepads generally feature a set of action buttons handled with the right thumb and a direction controller handled with the left. These controls typically give the player control of the game element movements in up to three dimensions, with many buttons to perform quick actions. Due to the ease of use and precision of gamepads, they have spread from traditional consoles where they originated to computers as a common input device.

Most modern game controllers are a variation of a standard gamepad. Some common additions to the standard pad include shoulder buttons placed along the edges of the pad, centrally placed buttons labeled start, select, and mode, and an internal motor to provide force feedback.

Gamepads are the primary means of input on nearly all modern video game consoles. Gamepads are also available for personal computers, but few computer games support gamepads, preferring the more conventional keyboards and mice.

### Paddle

A paddle is a controller that features a round wheel and one or more fire buttons. The wheel is used to typically control movement of the player or an object along one axis of the video screen.

### Joystick

A joystick is a computer peripheral that consists of a handheld stick that can be tilted around either of two axes and (sometimes) twisted around a third.

The joystick typically features a shaft with a sphere-like handle that is grasped, and one or more buttons for in game actions. Generally, the layout has the joystick on the left, and the buttons on the right. There are instances when this is reversed, or the joystick is in the center with button on both sides

### SUMMARY OF THE INVENTION

A problem associated with game controllers is a cramp where strain, muscle fatigue, muscle pain, and the like is felt on the thumbs and palm. This tends to occur mostly when using particularly small controllers or when any finger or hand is kept in an arched position for an extended period of time. Most controllers are designed to generally conform to the relaxed position of the hands. The pronged design of most controllers is based on the relaxed hand position that reduces soreness and cramping after extended use. However, this static design does not sufficiently reduce the occurrence of repetitive stress injuries (“RSI”) or carpel tunnel syndrome (“CTS”).

A game controller preferably has a central hub and a pair of wings. The pair of wings are preferably coupled to the central hub and configured to pivot about at least one axis with respect to the central hub.

In another embodiment, the game controller comprises a pair of wings, the pair of wings are configured to pivot with respect to each other about at least one axis.

A method of operating a game controller including connecting the game controller to at least one of a computer and a game console. Parameters are monitored including at least one of button presses, time, and wing position. A drive mechanism is activated based on the parameters, the drive mechanism varying a position of at least one of the pair of wings and the at least one button.

### BRIEF DESCRIPTION OF THE FIGURES

FIGS. 1A-1C are a front view of a game controller according to one embodiment of the invention;

FIGS. 2A-2C are a top view of a game controller according to one embodiment of the invention; and

FIG. 3 is a schematic view of the game controller according to one embodiment of the invention.

### DETAILED DESCRIPTION

The controller is the most common way of interacting with a game. According to one embodiment of the invention, the game controller is ergonomically designed so that it is comfortable and its use avoids injuries such as repetitive stress injuries (“RSI”) or carpel tunnel syndrome (“CTS”).

Disclosed is a game controller that preferably includes (1) one or more ten (10) axis controllers. In one embodiment, using motorization, the controller changes its relative position and angles relative to the user's hand(s). In one embodiment, the housing contacts the user's the palm, and the buttons on the outer surface come in contact with the user's fingers. In one embodiment, the two wings pivot about an axis. The palm area is adapted to alter its height relative to the finger position. This alters the user's finger and wrist angles. In one embodiment, the finger area will split apart into multiple zones and/or elongate to vary the finger angles in an unlimited number of ways. Such changes in the game controller occur under the control of a microprocessor, a timed controller, a programmed pattern, in accordance with the time used, amount of buttons clicked, by means of temperature, random motion, or in connection with game play changing at different coordinated times within a game. It is through this change that use of the controller can reduce the risks of RSI and CTS.

In one embodiment, the game controller includes a microprocessor. The microprocessor is programmed to analyze the data entry of the user using the game controller including button presses and movements of the 10-axis controller. After a fixed or random number of button presses and/or movements of the 10-axis controller, the microprocessor causes the game controller to change position. In one embodiment, the game controller moves at fixed or random intervals of time. While the game controller preferably utilizes an on-board microprocessors, in other embodiments, the game controller is controller via the game console or computer to which it is connected. In another embodiment, the game controller is controlled from a central server via a communication network such as the Internet.

In one embodiment, an onboard controller controls the game controller 100. The controller is located in the device or, in the computer or game console to which the game controller is connected. Communication takes place between the controller and the game controller via a WIFI connection, Bluetooth, RS232, USB, firewire, serial communication, parallel communication, or the like. The controller preferably has options such as velocity changes, button height change limitations, and the like; motion is controlled and monitored by switches, sensors, or the like. In one embodiment, the game controller 100 is controlled remotely or by other means either located on board, in the computer, or on a server.

Control software will preferably include, but not be limited to, programming aimed at relieving or preventing a specific disease such as carpal tunnel or other ailments due to repetitive motion. The gradual movements of the game controller 100 and more specifically the wings 104, 106 and the control buttons, eliminate repetitive motion from the same angle thereby improving blood flow, changing position of the median nerve, and resting overworked muscles.

The software programming will preferably monitor repetitive motion on specific buttons and adjust the game controller 100 components accordingly. If a user is constantly focusing on one button or 10-axis controller, then the programming will preferably adjust that section accordingly, moving it more frequently, or various other angles.

The software can be stored on the game controller 100 itself, the computer or game console to which it is attached, a third party computer or a server on the network, a dedicated hardware controller, or on an external source such as a key card or a USB memory card, solid state memory or other storage mechanisms.

In one embodiment, the customization of the software is manipulated by use of pre-programming, settings stored on the computer, game console, server, or by user input. The configuration changes can be made automatically when the user logs on the computer or game console. It can also be automatically configured with the help of biometrics or their personal key cards or identification cards. Once the user is identified, the software, wherever it is stored, can adjust the game controller for that specific user.

Another embodiment could offer hand and wrist rest temperature changes in addition to the other mentioned adaptations to alleviate common hand and wrist and arm ailments. To that end, the controller can be heated to warm a user's hands.

In one embodiment, the game controller 100 works with stored settings on a game console. The user's game controller 100 settings are stored in conjunction with game play. In other words, a game controller 100 profile is maintained to provide customized movement to user.

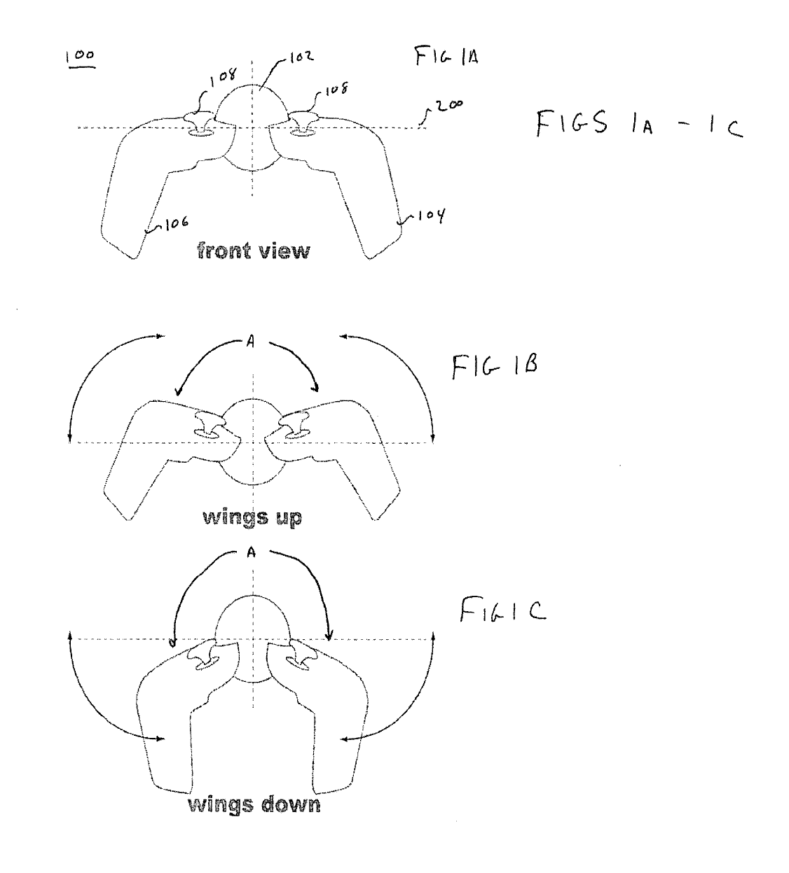

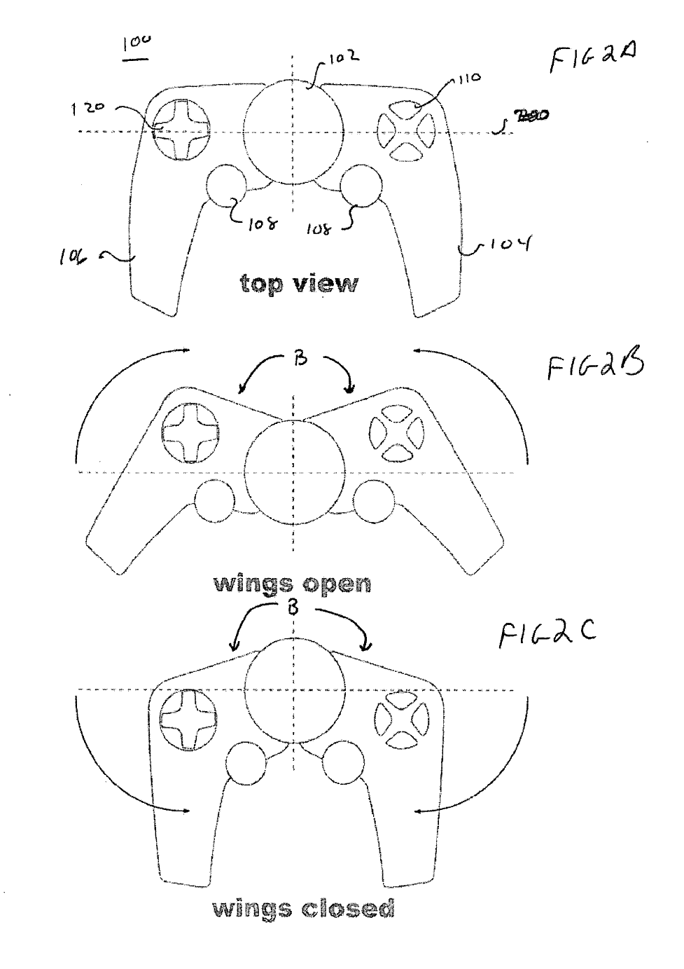

FIG. 1A is a front view of a game controller in accordance with one embodiment of the invention. As shown in FIG. 1A, a controller 100 includes a center portion 102 and side portions or wings 104 and 106. The side portion or wings 104, 106 are the handles of the game controller. In a preferred embodiment, the wings 104, 106 are molded to a human hand. The wings 104, 106 are adapted to be grasped as is known in the game controller art. Additionally, as shown, controller 100 includes two multi-axis controllers 108. Multi-axis controllers 108 are preferably 10-axis controllers. Additionally, the Controller 100 can include a plurality of control buttons (FIG. 2). While the center portion is shown as a ball in the disclosed embodiment, any configuration is possible.

The handle portions 104 and 106 are adapted to be moveable from a rest position shown in FIG. 1A. Specifically, the wings 104 and 106 are adapted to move in a direction to increase or decrease an angle A between the angles or wings 104, 106. In a preferred embodiment, a motor is housed in central portion 102. The motor drives a gear train that moves the wings 104, 106. In another embodiment, the wings are driven by magnetic drive. In yet another embodiment, a self-winding spring or a drive mechanism driven by friction, or the like drives the motion.

As shown, during use the use of game controller 100, the wings 104, 106 move imperceptibly to the user. In another embodiment, the motions are stepped in a manner noticeable by the user. In yet another embodiment, the driving means disengage so that the wings 104, 106 can be moved as an additional gaming input. The drive means for the wings are disengaged by the game so that the wings are useable as inputs. The user can move the wings 104, 106 to vary the gameplay.

FIGS. 2A-2C are a top view of controller 100. As shown, the controller 100 includes buttons such as 110 and a rocker button such as 120. The controller 100 begins at an initial rest position shown in FIG. 2A. From this initial resting period the wings 104, 106 are adjustable so that an angle B between the wings is decreased as shown in FIG. 2B or increased as shown in FIG. 2C.

It should be noted that the motion shown in FIGS. 1A to 1C with angle A being varied and/or the wings being rotated about axis 200 and/or the motion shown in FIGS. 2A to 2C with Angle B being varied can be performed in combination or independent of one another. Further, the position of the controllers 108 can be varied relative to the position of the wings 104,106. Additionally, the plane of buttons 110 and 120 can be varied with respect to wings 104, 108. In other words, the buttons can be raised or lowered from the surface of the controller. In another embodiment, the buttons 110, 120 are moved along the face of the top surface of the game controller 100.

The wings 104, 106 moved with respect to hub 102 using a motor, springs, gears, piezoelectric elements, magnetic elements, and the like. The power for the motion is drawn from batteries, a USB port, solar power, or the like. In yet another embodiment, a self-winding spring or a drive mechanism driven by friction, or the like drives the motion. In other words, both motorized and non-motorized drive mechanisms can be used.

Wings 104 and 106 change position in response to a number of factors, taken together, in any combination, or individually. Specifically, the factors include, but are not limited to time used, game play, button activation, controller activation, position, and the like. The wings 104, 106 can move in a continuous motion or the motion may be periodic. Further, the wings and or buttons may step through a series of predetermined positions or may make random movements. In one embodiment, an exercise game is played to exercise the user's hand and fingers to avoid RSI or CTS.

In one embodiment, the controller includes a motion sensor. The motion sensor is adapted both to enhance game play as well as provide an input whereby the controller is controlled so that wings 104, 106 and/or buttons 110,120 are moved.

In one embodiment, the controller 100 includes a controller (not shown) configured to control the motion of the controller 100. The controller can be a microprocessor or other hardware and software adapted to control controller 100. In another embodiment, the motion of the controller is controlled by the gaming hardware. It should be noted that in one embodiment, the motion of wings 104, 106 provides an additional input for game play.

While FIGS. 1A-1C and FIGS. 2A-2C each depict motion in a single axis, it should be noted that in one embodiment, the wings 104, 106 is also adapted to also rotate about axis 200. The wings 104, 106 can pivot about axis 200. Each wing 104, 106 can move simultaneously or individually. In one embodiment, a first wing moves about at last one axis and a second wing moves about another axis. Thus, the wings 104, 106 are adapted to pivot or rotate about at least one axis, and as disclosed, about three axes.

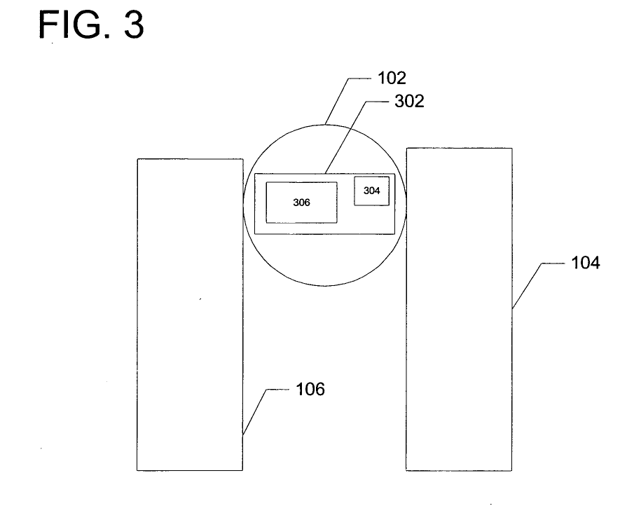

FIG. 3 depicts a schematic representation of controller 100. There is a drive 302 in hub 102. In one embodiment, drive 302 comprises driver 304 such as a motor and a gear train 306. Gear train 306 is comprises one or more of a spur gear, a straight or spiral cut bevel gear, a worm gear, a planetary gear, a hypoid gear a helical gear, a herringbone gear, or the like. In one embodiment, a plurality of gear arrangements are utilized to provide motion of wings 104, 106 about three axes with respect to hub 102. In one embodiment, a drive 302 includes a transmission to disengage the motor to allow the user to adjust the wings. It should be noted that in one embodiment, the user sets the wing position. Additionally, the drive 302 is configured to vary the positions of the buttons 110, 120 and multi axis controller 108.

While this invention has been described by reference to a preferred embodiment, it should be understood that numerous changes could be made within the spirit and scope of the inventive concepts described. Accordingly, it is intended that the invention not be limited to the disclosed embodiment, but that it have the full scope permitted by the language of the following claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A game controller comprising:
a central hub;
a pair of wings, the pair of wings are coupled to the central hub and configured to pivot about at least one axis with respect to the central hub; and
a drive mechanism coupled to the pair of wings and configured to pivot the pair of wings about the at least one axis.

2. The game controller according to claim 1, wherein the pair of wings are configured to pivot about at least two axes with respect to the central hub.

3. The game controller according to claim 2, wherein the drive mechanism, the drive mechanism is coupled to the pair of wings and configured to pivot the pair of wings about the at least two axes.

4. The game controller according to claim 3, wherein the drive mechanism comprises a motor and a gear train.

5. (canceled)

6. The game controller according to claim 3, further comprising at least one multi-axis controller and at least one button, the at least one multi-axis controller and at least one button mounted to at least one of the pair of wings and the central hub.

7. The game controller according to claim 6, wherein at least one of the multi-axis controller and at the least one button is coupled to the drive mechanism.

8. The game controller according to claim 7, wherein the at least one button is configured to be driven by the drive mechanism to raise from a surface of the game controller.

9. The game controller according to claim 3, wherein the drive mechanism pivots the pair of wings when a predetermined condition occurs.

10. The game controller according to claim 9, wherein each of the wings is adapted to move independently.

11. The game controller according to claim 3, wherein the pair of wings move in a synchronized manner.

12. The game controller according to claim 9, wherein the predetermined condition is customized based at least in part on a desired motion.

13. The game controller according to claim 3, further comprising a controller, said controller adapted to monitor parameters including at least one of button presses, time, and position of the pair of wings, said controller activating the drive mechanism based on the parameters.

14. The game controller according to claim 13, wherein the controller is integral to the game controller.

15. The game controller according to claim 13, wherein the controller is a portion of at least one of a computer and a game console to which the game controller is connected.

16. A game controller comprising:
a pair of wings, the pair of wings are configured to pivot with respect to each other about at least one axis;
at least one multi-axis controller mounted on at least one of the pair of wings;
a drive mechanism coupled to the pair of wings and configured to pivot the pair of wings about the at least one axis and
at least one button mounted on at least one of the pair of wings.

17. A method of operating a game controller, the game controller comprising a central hub and a pair of wings, the method comprising:
connecting the game controller to at least one of a computer and a game console;
monitoring parameters including at least one of button presses, time, and wing position;
activating a drive mechanism based on the parameters, the drive mechanism varying a position of at least one of the pair of wings and the at least one button.

18. The method of operating the game controller according to claim 17, wherein the pair of wings are pivoted about at least one axis.
